(19) United States
(12) Patent Application Publication
(10) Pub. No.: US 2012/0285897 A1
(43) Pub. Date: Nov. 15, 2012

(54) Apparatus and Method for Maintaining Potable Water

(75) Inventors: Jess Edward Fike, Youngsville, LA (US); David Wayne Gautreaux, Carencro, LA (US)

(73) Assignee: H2O, Inc.

(21) Appl. No.: 13/103,472

(22) Filed: May 9, 2011

(51) Int. Cl. C02F 1/66; C02F 1/76; C02F 103/04

(52) U.S. Cl. 210/743; 210/96.1; 210/85

(57) ABSTRACT

An apparatus for maintaining potable water stored in a tank. The apparatus is automated and self-contained. When fluidly connected to a water storage tank, the apparatus causes continuous circulation of the potable water to prevent contamination resulting from stagnation and stratification. The apparatus also monitors the amount of free chlorine in the potable water, the pH level, and the amount of total dissolved solids (“TDS”). If the potable water contains less than a predetermined amount of free chlorine or if the pH level is less than a predetermined level, the apparatus automatically adds a selective amount of chlorine and/or minerals to the potable water. The apparatus will also filter the potable water to remove suspended solids.

### BACKGROUND OF THE INVENTION

The present invention relates to an apparatus and method for maintaining potable water.

### SUMMARY OF THE INVENTION

The present invention is drawn to a novel apparatus for maintaining potable water. The apparatus has a frame assembly including a bottom plate and a frame support structure. The bottom plate has a topside and an underside. The frame support structure is affixed to the topside of the bottom plate. The apparatus also includes a plurality of conduits for transporting water. The plurality of conduits are in fluid communication. The apparatus further includes a circulation pump in fluid communication with the plurality of conduits. The circulation pump is capable of pumping the potable water through the plurality of conduits. The apparatus has a sensor array assembly also in fluid communication with the plurality of conduits. The sensor array assembly includes a first sensor probe capable of detecting the amount of free chlorine present in the potable water, a second sensor probe capable of detecting the pH level of the potable water, and a third sensor probe capable of detecting the amount of total dissolved solids in the potable water.

The apparatus further has a chlorine tank in fluid communication with the plurality of conduits and a chlorine dosing pump in fluid communication with the plurality of conduits and also with the chlorine tank. The chlorine dosing pump is selectively activated in response to the detection by the first sensor probe of the amount of free chlorine in the potable water. The chlorine pump, when activated, pumps a specified amount of chlorine from the chlorine tank into the potable water flowing in the apparatus. The apparatus includes a mineral tank in fluid communication with the plurality of conduits. The mineral tank is capable of selectively delivering a specified amount of minerals into the potable water in response to the detection by the second sensor probe of the pH level in the potable water. Finally, the apparatus has a filter assembly in fluid communication with the plurality of conduits. The filter assembly is capable of selectively filtering the potable water to remove a predetermined particle size of suspended solids from the potable water.

In another embodiment, the apparatus includes a pressure switch assembly in fluid communication with the plurality of conduits. The pressure switch assembly protects the circulation pump from dry running.

In yet another embodiment, the apparatus has a first plurality of valve means operatively associated with the mineral tank. The selective delivery of the specified amount of minerals into the potable water in response to the detection by the second sensor probe of the pH level in the potable water is caused by actuation of the first plurality of valve means. The first plurality of valve means is selected from the group consisting of ball valves, spring loaded check valves, diaphragm valves and pilot solenoid valves.

In a further embodiment, the apparatus has a second plurality of valve means operatively associated with the filter assembly. The selective filtering of the potable water to remove the predetermined particle size of suspended solids from the potable water.

The plurality of conduits may be PVC piping.

The filter assembly may be one or more filter cartridges.

One of the plurality of conduits may include an inlet for entry of the potable water from a storage tank into the apparatus and one of the plurality of conduits may include an outlet for discharge of the potable water from the apparatus to the storage tank. The apparatus may include a discharge member in fluid communication with the outlet. The discharge member may have a longitudinally extending distribution arm containing a plurality of spaced-apart discharge orifices capable of distributing the potable water discharged from the outlet into the storage tank. The spaced-apart discharge orifices may each have a differently sized inner diameter. The said spaced-apart discharge orifices may also be positioned on the distribution arm in axial alignment from an upper section of the distribution arm to a lower section of the distribution arm with the orifice having the smallest sized inner diameter positioned in the upper section and the orifice with said largest sized inner diameter positioned in the lower section.

In yet another embodiment of the invention, the apparatus may include a control panel operatively associated with the first, second and third sensor probes. The control panel may include a plurality of visual instrument displays. The apparatus may also have an electrical junction box housing a plurality of electrical leads. The junction box may be operatively connected to the control panel and to the chlorine pump. The control panel may include an alarm providing a visual signal, audible signal, or combination of a visual and audible signal in response to a malfunction of the apparatus.

In an embodiment, the plurality of conduits of the apparatus includes a bypass line capable of diverting a portion of the potable water to a return line that discharges the portion of the potable water into a storage tank prior to the portion of the potable water entering the mineral tank and the filter assembly.

The present invention is also directed to a method of maintaining potable water stored in a storage tank having an outlet means and an inlet means. The method involves the steps of providing an apparatus for maintaining potable water as described hereinabove. The method includes placing the inlet of the one of the plurality of conduits in fluid communication with the outlet means of the storage tank. The method includes placing the outlet of the one of the plurality of conduits in fluid communication with the inlet means of the storage tank. The method includes activating the circulation pump to pump the potable water stored in the storage tank through the plurality of conduits. The method includes causing a first stream of the potable water to pass through the sensor array assembly wherein the first sensor probe detects the amount of free chlorine present in the potable water, the second sensor probe detects the pH level of the potable water, and the third sensor probe detects the amount of total dissolved solids in the potable water. The method includes causing a second stream of the potable water to be selectively directed through the plurality of conduits in response to the detection by the second sensor probe of the pH level of the potable water. The method includes causing activation of the chlorine pump to add a specified amount of a diluted chlorine mixture contained in the chlorine tank to the potable water or maintaining an inactive state of the chlorine pump in response to the detection by the first sensor probe of the amount of free chlorine in the potable water.

In an embodiment, the method includes causing the diversion of the second stream of the potable water through the plurality of conduits so as to by-pass the mineral tank and the filter assembly.

In a further embodiment, the method includes causing a partial diversion of the second stream of said potable water through the plurality of conduits for entry into the mineral tank for addition of a specified amount of minerals while by-passing the filter assembly.

In still a further embodiment, the method includes causing the partial diversion of the second stream of the potable water through the plurality of conduits for entry into the mineral tank for addition of a specified amount of minerals and through the plurality of conduits for entry into the filter assembly for filtering of the dissolved solids.

In an embodiment, the first stream of the potable water passing through the sensor array assembly is selectively controlled at a flow rate of 1 to 5 gallons per minute.

In an embodiment, the first stream of the potable water passing through the sensor array assembly is selectively controlled at a flow rate of about 3 gallons per minute.

In an embodiment, the partially diverted second stream of the potable water entering the mineral tank is selectively controlled at a flow rate of 10 to 50 gallons per minute.

In an embodiment, the partially diverted second stream of the potable entering the mineral tank is selectively controlled at a flow rate of about 10 gallons per minute.

### BRIEF DESCRIPTION OF THE DRAWINGS

FIG. 1 is a front perspective view of an embodiment of the present invention.

FIG. 2 is a rear perspective view of the embodiment of the present invention shown in FIG. 1.

FIG. 3 is a partial exploded view of the embodiment of the present invention shown in FIG. 1.

FIG. 4 is a flow diagram of an embodiment of the present invention.

FIG. 5 is a perspective view of the frame assembly of the embodiment of the present invention shown in FIG. 1.

FIG. 6 is a cross-sectional view of a potable water storage tank containing a discharge member component of the present invention.

### DETAILED DESCRIPTION OF THE INVENTION

In certain work and residential environments potable water is supplied by and maintained in a storage tank. Such is the case for offshore oil and gas drilling and production platforms where no publicly available source of potable water is available. On offshore platforms, potable water is brought to the platform via a work boat or other like transportation. During transport the potable water may be held in one or more storage tanks that are hoisted onto the platform and connected to the platform's water distribution system. Alternatively, the water may be transferred from a storage tank in the work boat to one or more storage tanks maintained on the platform which are connected to the platform's water distribution system. The water stored in the storage tanks is used by personnel working on the platform for a variety of purposes including drinking, bathing, cooking, and the like.

Potable water for offshore platforms and other remote environments may also be produce from sea water by reverse osmosis equipment or other distillation equipment that converts salt water to potable water safe to drink. Water produced by such methods may also be stored on the platform in storage tanks.

Federal regulations, such as the Environmental Protection Agency's Safe Drinking Water Act, provide standards governing the suitability of potable water. The regulations recognize the existence of three primary parameters to maintaining potable water: (1) total dissolved solids, (2) free chlorine residual, and (3) pH level.

Regulations require that a minimum free chlorine residual be maintained in potable water at all times to prevent algae and bacterial growth. As potable water sits stagnant in a storage tank it undergoes thermal stratification. The chlorine, placed in the water as a preventative against algae and bacterial growth, sinks to the bottom of the tank because it weighs more than water. Therefore, the water at or near the surface is much more susceptible to algae and bacterial growth. Not only will algae and bacteria grow in this area, it will spread to the side of the tank. Proper circulation of the stored water is necessary to maintain an even distribution of the chlorine or other disinfectant to prevent algae and bacterial growth that renders the water unsuitable for consumption.

Potable water produced by reverse osmosis or other distillation process has a low pH level. The low pH level results from the water-making equipment's rejection of not only salts, such as sodium chloride, but other minerals such as calcium and magnesium, which help regulate a balanced pH level. The resulting water is fresh and of high quality but is mineral deficient and low in pH. Water having a low pH level may be aggressive as it tries to neutralize itself by dissolving minerals and/or metals that the water comes into contact with. This can cause piping to be attacked in the pipe system downstream of the equipment.

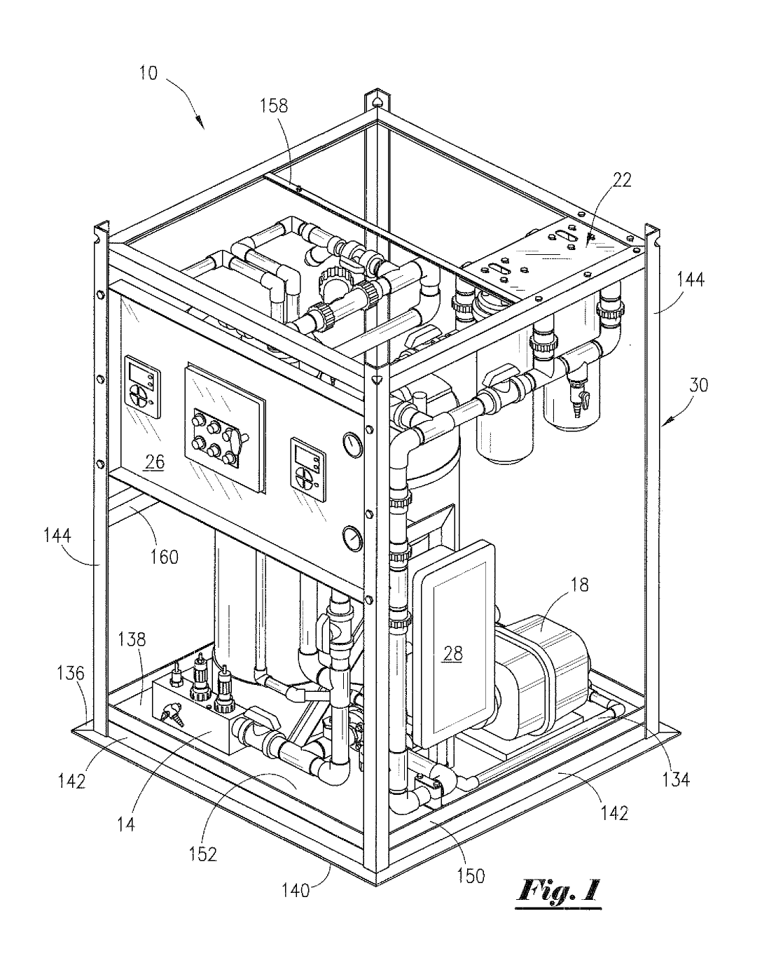

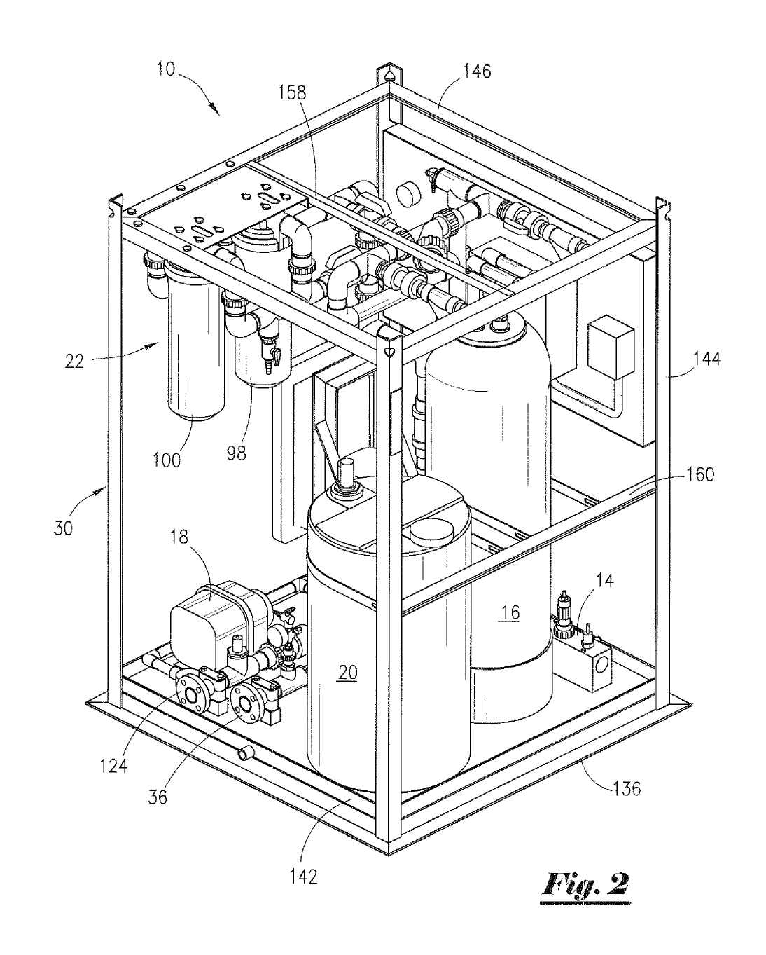

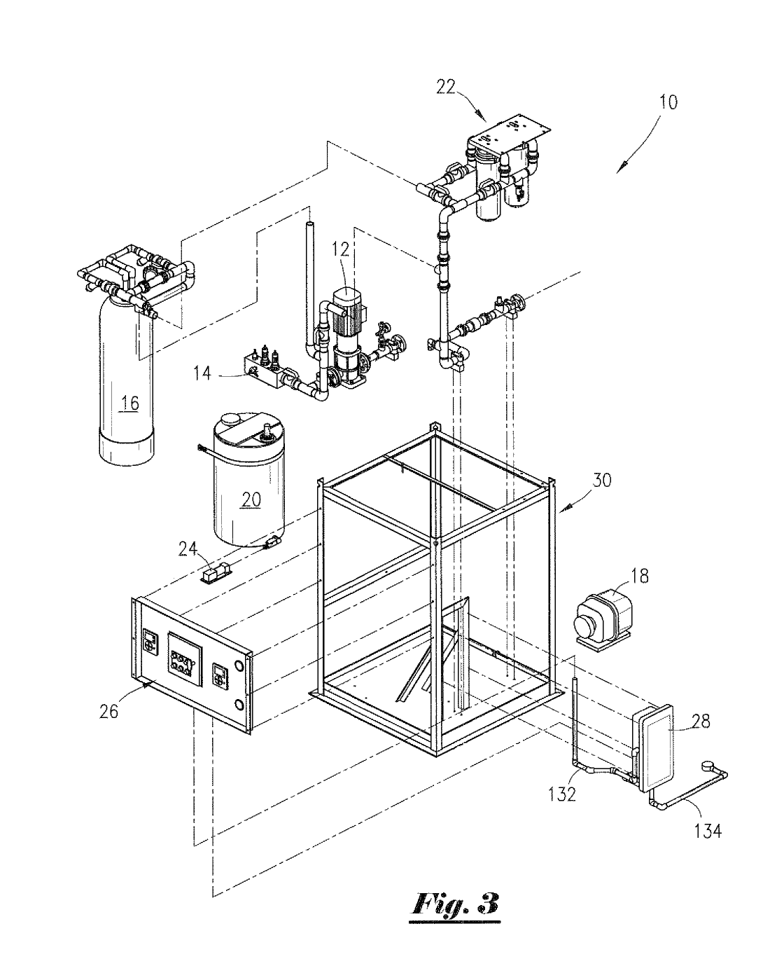

FIGS. 1-3 show the primary operational components of apparatus 10. Those components include circulation pump 12, sensor array assembly 14, mineral tank 16, chlorine pump 18, chlorine tank 20, filter assembly 22, pressure switch assembly 24, control panel assembly 26, and electrical junction box 28. Circulation pump 12, sensor array assembly 14, mineral tank 16, chlorine pump 18, chlorine tank 20, filter assembly 22 and pressure switch assembly 24 are in fluid communication via a series of flow lines, which may be PVC conduit or the like. Circulation pump 12, sensor probe assembly 14, chlorine pump 18, pressure switch 24, control panel assembly 26 and electrical junction box 28 are in electrical communication via a series of electrical lines housed within conduits, which may be PVC conduit, insulated conduit, or the like. The components are housed within and supported by frame assembly 30. The size of the PVC pipe may vary. It is suggested that 1½ inch PVC pipe is used.

When operatively associated with a potable water storage tank, apparatus 10 circulates the potable water stored in the tank to prevent the water's stagnation. Apparatus 10 also monitors certain conditions of the stored water such as the amount of total dissolved solids (“TDS”), the amount of free chlorine, the pH level, and temperature. Apparatus 10 can also treat the stored water by adding free chlorine, filtering solids (e.g., suspended solids), adjusting the pH level higher, and adding nutrient minerals.

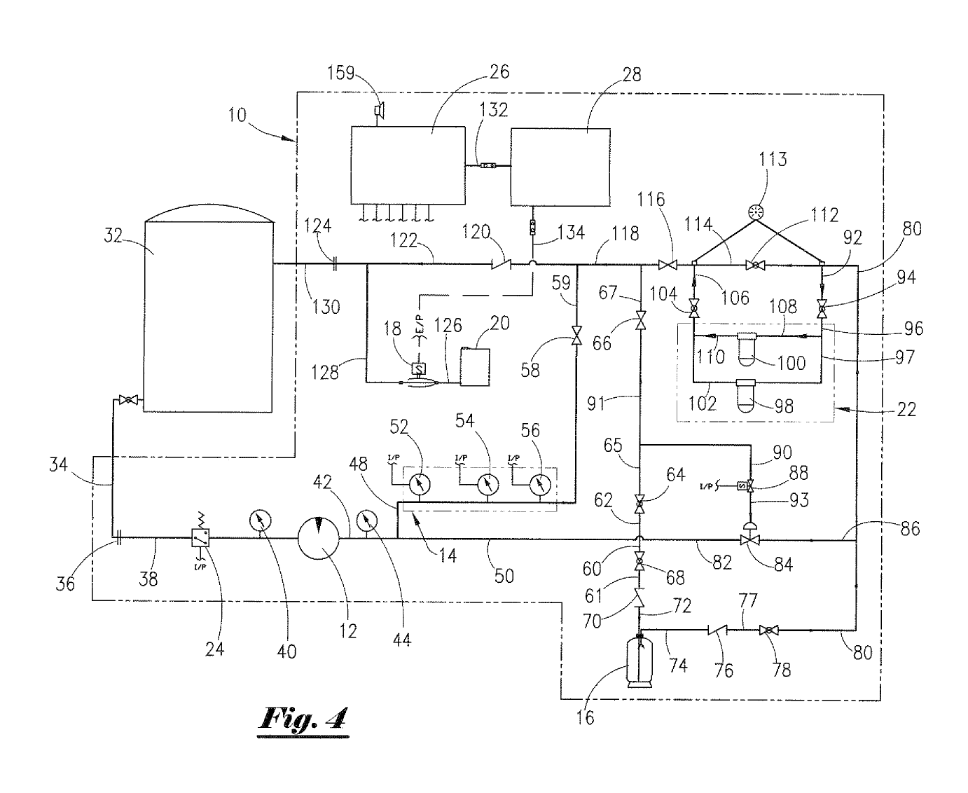

FIG. 4 depicts a flow diagram for apparatus 10 when operatively associated with a potable water storage tank 32. Potable water tank 32 is in fluid communication, via line 34, with apparatus 10. Water enters apparatus 10 via inlet 36 and flows through line 38 to circulation pump 12. Circulation pump 12 operates to create the flow of potable water from storage tank 32 through apparatus 10 and back to storage tank 32. Line 38 contains pressure switch assembly 24 and pressure gauge 40. Pressure switch assembly 24 operates to maintain a specific flow pressure within apparatus 10 in order to insure that all of the potable water stored within water tank 32 is circulated through apparatus 10 about every 24 hours. Pressure switch assembly 24 protects circulation pump 12 from running dry. Pressure gauge 40 provides a measurement of the flow pressure within line 38.

As seen in FIG. 4, water exits pump 12 via line 42. A second pressure gauge 44 is positioned in line 42 and measures the flow pressure at the exit end of pump 12. Line 42 ends at the point of diversion of line 48 and line 50.

Again with reference to FIG. 4, line 48 diverts some of the water from tank 32 and flows the water to sensor array assembly 14. Sensor array assembly 14 may include a number of different types of sensors that will measure specific components of the water flowing through apparatus 10. For example, sensor array assembly 14 may contain sensor probe 52 that detects the pH level of the water, sensor probe 54 that detects the amount of free chlorine in the water, and sensor probe 56 that detects the amount or presence of total dissolved solids in the water. Probe 52 is commercially available from Rosemount Analytical under model No. 399-09-62. Probe 54 is commercially available from Rosemount Analytical under model No. 499ACL-01-54-60. Probe 56 is commercially available from Rosemount Analytical under model No. 400-13. Sensor 56 also is capable of measuring the temperature of the water. After passing through sensor assembly 14, the water flows through line 48 to flow control valve 58 and then through line 59 to line 118.

Sensor assembly 14 performs at an optimal operational capability when a predetermined flow rate passes through assembly 14 and comes into contact with probes 52-56. For example, a flow rate of one to five gallons of water per minute is suggested to achieve optimal performance. A flow rate of three gallons of water per minute is also suggested to achieve optimal performance.

The water not diverted through sensor assembly 14 flows through line 50 until line 50 intersects with lines 60, 62, and 82. Line 60 contains ball valve 68. Line 61 extends between valve 68 and spring loaded check valve 70. Flow continues from spring loaded check valve 70 via line 72 to the entry point of mineral tank 16. Mineral tank 16 contains one or more minerals to be added to the water. For example, tank 16 may contain calcium or a combination of magnesium and calcium in a 60/40 mixture. A suitable magnesium/calcium mixture is commercially available from Watts Water under the trademark CALCITE. In addition to adding nutritional minerals to the water, the minerals may also act to adjust the pH level of the water if required. To achieve optimal dispersion of the minerals from mineral tank 16 into the water, it is suggested that the flow rate of the water through tank 16 be fixed at 10 to 45 gallons of water per minute or at about 10 gallons of water per minute.

After being treated in tank 16, the treated water exits tank 16 through line 74 which ends at spring loaded check valve 76. Line 77 extends between valve 76 and ball valve 78. Treated water passing through ball valve 78 exits into line 80 which is in fluid communication with filter assembly 22.

Again with reference to FIG. 4, line 62 extends to ball valve 64. Line 65 runs from ball valve 64 to the intersection point of lines 90 and 91. Line 91 is in fluid communication with variable flow control valve 66. Line 67 extends between valve 66 and line 118. Line 90 runs between line 65 and pilot solenoid valve 88 which fluidly connects with actuated diaphragm valve 84 via line 93. Valve 84 is positioned between line 82 and line 86, which directs the flow from valve 84 to line 80 and from there to filter assembly 22.

The addition of minerals from tank 16 into the water flow is directed by the coordinated opening of valves 68, 70, 76 and 77 and closure of valves 64 and 84. Valve actuation is controlled by instrumentation in control panel 26 operatively associated with sensor probe 52 that detects the pH level of the water. If sensor probe 52 detects that the pH level in the water is below a pre-determined level (e.g., below a pH of 7 and therefore acidic), a signal will be sent to instrumentation in control panel 26 that will initiate actuation of the valves directing the flow of water from line 50 through line 60 and eventually to tank 16 where the pH level is adjusted by adding a certain amount of pH adjusting minerals to the water to bring the pH level to the pre-determined level.

The water flows out of tank 16 into filter assembly 22 via line 80 where depending on the amount of total dissolve solids contained in the water, the water may flow through filters 98, 100 which will be described herein. If the pH level detected by probe 52 is at or below the specified pH level, the valves, such as valve 68, may remain closed thereby diverting the water from line 50 either through line 62 or line 82 depending on whether filtering of the water is required.

Probe 56 detects the amount of total dissolved solids in the water which then sends a signal to instrumentation in control panel 26 for monitoring purposes. Typically, the water is continually passed through filter assembly 22 for the removal of suspended solids based on the particle filtering size of the filtering means of assembly 22. Valves 68, 64, and 84 may be actuated such that the water flows from line 50 through line 62, through valve 64 and into line 65 where it proceeds through line 91, through valve 66 and to line 118. The valves may also be actuated such that valve 84 is opened and valve 64 and 68 are closed such that water is diverted from line 50 through line 82, through valve 84 to line 86, which then directs the flow into line 80 and to filtering assembly 22.

Instrumentation in control panel 26 will then actuate additional valves that will be described herein with respect to filter assembly 22 to direct the flow from line 80 through line 92 to valve 94. To flow water through filter assembly 22, water flows from valve 94 via line 96 and continues either through line 97 to filter 98 or through line 108 to filter 100. After the solids are filtered by filter 98, the filtered water then flows through line 102, through valve 104, through line 106 and into line 114. The filtered water exiting filter 100 flows through line 110 and into line 102 for passage through valve 104 to line 106 and then eventually to line 114. Filter assembly 22 may use one or more filter cartridges 98, 100. The filters may have a variety of micron sizes. For example, filters 98, 100 may have a pore size of five microns, which has been found effective to filter the TDS. Filter assembly 22 is commercially available from Pentek Filtration under model No. #20 BigBlue 1½″. Filter assembly 22 may also include differential pressure gauge 113 that detects the pressures in lines 80 and 114.

The diversion of water from line 80 through filters 98, 100 occurs by the opening of valve 94 and the closure of valve 112 situated between line 80 and line 114. Filters 98 and 100 can be bypassed by closing valves 94, 104 and opening valve 112. From line 114 the water flows through variable flow control valve 116 and into line 118. Line 118 proceeds to spring valve 120. Line 122 extends between spring valve 120 and outlet 124. Line 130 connects to outlet 124 to a return inlet in tank 32.

Apparatus 10 further includes chlorine tank 20 which is in fluid communication with chlorine pump 18 via line 126. Line 128 connects pump 18 to line 122. Once sensor probe 54 detects that the level of free chlorine in the potable water is below a predetermined amount sufficient to maintain the safety of the water for human consumption, sensor probe 54 sends a signal to instrumentation in control panel 26 which in turn actuates chlorine pump 18 causing a specified amount of chlorine contained within chlorine tank 20 to be pumped into water line 122 via lines 126 and 128.

The amount of chlorine pumped into the water flowing through apparatus 10 may vary depending on the amount of free chlorine detected by probe 54. For example, the amount of free chlorine to be maintained in the water may be between 0.5 and 1.0 parts per million. Therefore, the amount of free chlorine to be added into the potable water from chlorine tank 20 should be in an amount to bring the free chlorine present in the water to an amount ranging from 0.5 to 1.0 parts per million. The size of chlorine tank 32 may vary. For example, chlorine tank 32 may hold between 20 and 50 gallons of diluted chlorine, e.g., a mixture of chlorine and water in a 1/34 ratio. It is suggested that chlorine tank 32 hold about 35 gallons of diluted chlorine. Chlorine tank 32 is commercially available from Clack Corporation under model No. G21832BN7C00.

Electrical power for apparatus 10 may be supplied by a variety of sources such as a generator or battery. Electrical power may be transmitted from the power source to apparatus 10 via connection with junction box 28. Box 28 may have the following specifications: 480 VAC, 3 Ph, 60 H2, 4 amps. All electrical components that may arc should be contained within junction box 28, which preferably is explosion resistant. Electricity powering the instrumentation contained in control panel 26 may be provided by electrical lines running through electrical conduit 132 extending between junction box 28 and control panel 26. Electrical lines supplying the power to chlorine pump 18 may be provided via conduit 134 positioned between junction box 28 and chlorine pump 18. While electrical power is one source for operating various components of apparatus 10, as for example, circulation pump 12 and chlorine pump 18, it is to be understood that other power sources such as pneumatic or hydraulic power could be used to operate the components, including circulation pump 12 or chlorine pump 18.

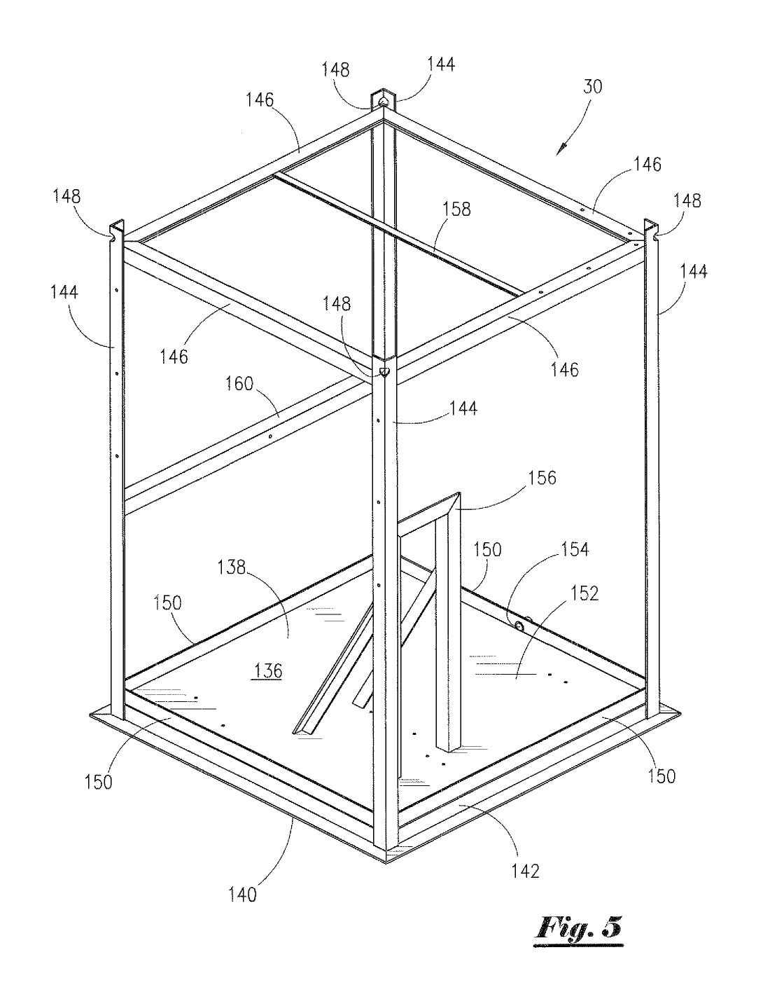

FIG. 5 shows frame assembly 30. Frame assembly 30 includes bottom plate 136 which has topside 138 and underside 140. It is to be understood that bottom plate 136 can be made in a variety of constructions. For example, bottom plate 136 could be formed of discrete, spaced-apart horizontally extending support members. Although not shown in FIG. 5, skids may be attached to underside 140 of bottom plate 136 to facilitate transport of apparatus 10. Lower support members 142 are positioned about the outer periphery of bottom plate 136 on topside 138. The ends of lower support members 142 are affixed to vertical support posts 144 at the lower end of each post 144. Upper support members 146 are affixed to the upper ends of posts 144. The upper end of each post 144 contains opening 148 to receive a chain or other lifting means so that apparatus 10 may be hoisted for transport.

With reference to FIG. 5, containment members 150 are affixed to support members 142 to create a interior containment area 152 that will capture or retain any fluids that may, for example, leak while apparatus 10 is in use. Outlet 154 is provided to selectively permit any fluids contained within area 152 to be discharged therefrom. Sub-frame 156 is fixedly attached to topside 138 of bottom plate 136 to provide a support means for the placement of junction box 28. Retaining bar 158 is fixedly attached between two adjacent upper support members 146 in order to provide structure for the placement of filter assembly 22 about frame assembly 30. Retaining bar 160 is fixedly positioned between two adjacent posts 144 to provide a support means to contain mineral tank 16 and chlorine tank 20 which tanks may be strapped to bar 160. Two adjacent posts 144 also provide a support means for the placement of control panel 126 on frame assembly 30.

Frame assembly 30 may be made of a hard material capable of structurally supporting the components of apparatus 10. For example, frame assembly 30 may be made of metal such as aluminum. When made of metal, the various component parts of frame assembly 30 may be connected by any suitable means such as welding or braced together by bolts, screws, rivets, or the like.

Frame assembly 30 may be detachably affixed to the structure where apparatus 10 is positioned for operational purposes. For example, bottom plate 136 may be detachably affixed to the floor upon which apparatus 10 is placed for operation. Such detachable fixation means may include securing bottom plate 136 to the floor by bolts or screws.

Control panel 26 may contain instrumentation displays showing a representation of the operational parameters of the components of apparatus 10 such as flow rates, pump rates, circulation cycles, and the like. Instrumentation on control panel 26 may also show a representation of the conditions of the water such as temperature, pH level, quantity of free chlorine, and quantity of total dissolved solids.

As depicted in FIG. 4, control panel 26 may also contain alarm 159. Alarm 159 may provide a visual signal and/or an audible signal when certain warning conditions of the operational capabilities of apparatus 10 are not properly functioning or when certain conditions in the water are present. For example, if water from storage tank 32 is not properly flowing into or through apparatus 10, one or more sensor in apparatus 10 will signal the activation of alarm 159. Activation of alarm 159 serves to notify personnel that apparatus 10 is not performing properly.

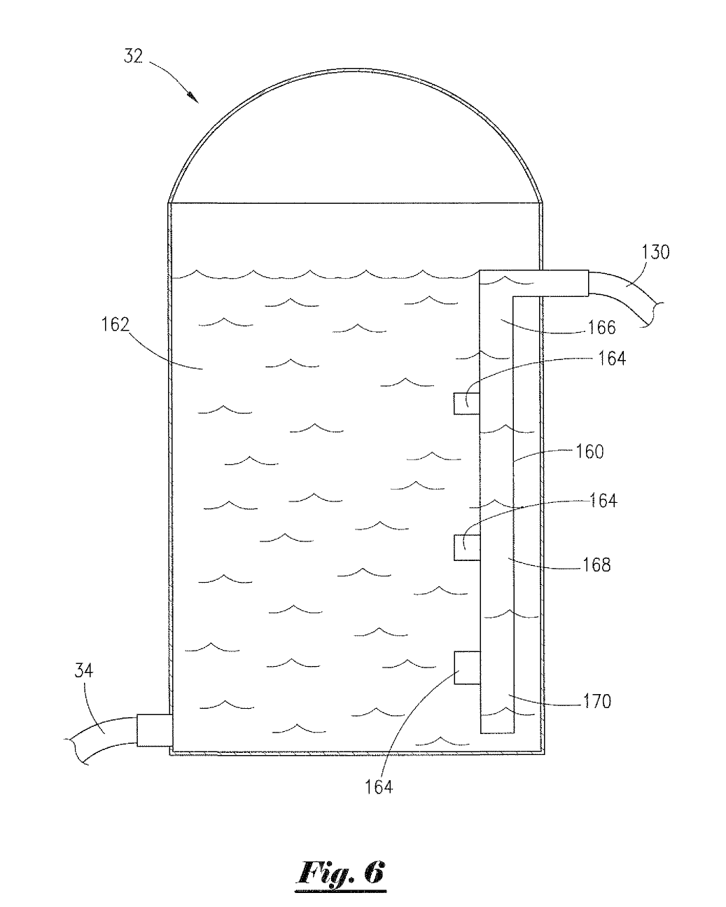

FIG. 6 shows tank 32 with discharge member 160 situated within interior 162 of tank 32. Discharge member 160 is in fluid communication with outlet line 130 which transports treated water from apparatus 10 back to tank 32 for storage. Discharge member 160 may contain one or more discharge orifices 164 for discharge of the treated water into interior 162 of tank 32. Discharge orifices 164 may contain variable restricted diameters to insure that the treated water is equally distributed throughout tank 32. For example, the inner diameter of orifice 164 at upper section 166 may be smaller than the inner diameter of orifice 164 of middle section 168. Similarly, the inner diameter of orifice 164 of middle section 168 may be smaller than the inner diameter of orifice 164 of lower section 170. Discharge member 160 functions to provide equal distribution of the treated water throughout tank 32 to lessen the effects of stratification.

Discharge member 160 may be made of any suitable material such as hardened plastic or metal. The size of discharge member 160 may depend on the size or shape of tank 32. For example, discharge member 160 may be useful for circulating within tanks that are of an extending cylindrical length or tanks having a capacity in the range of 2,000 gallons to 500,000 gallons. While discharge member 160 may be made in a variety of sizes and shapes, as an example, discharge member 160 may have a length of 300″, an outer diameter of 2″; and an inner bore diameter of 1.5″. Orifices 164 may have an inner diameter ranging from 0.125″ to 1.0″.

Apparatus 10 may be operated with or without the use of discharge member 160. When due to the size of tank 32, apparatus 10 (and the circulation of the potable water through the system) is insufficient to prevent stratification, discharge member 160 may be used to prevent stratification by distributing the treated water throughout the entirety of tank 32 from the upper to the lower regions thereof.

Apparatus 10 is designed as an automated, stand-alone unit capable of maintaining stored potable water in condition for human use and consumption. By continuously circulating the water stored in tank 32, the free chlorine present in the water is better dispersed so as to reduce or eliminate the deleterious effects caused by water stagnation and stratification. Stagnant water is more susceptible to contamination because the colder and heavier particles, such as chlorine, migrate to the bottom of tank 32. Water at the upper end of tank 32 is therefore more amenable to contaminant growth such as algae and bacteria. Continual circulation or movement of the water, as achieved by apparatus 10, eliminates the problems associated with stagnation or stratification. Apparatus 10 also keeps the water in potable condition by evaluating the level of free chlorine and adding a specified amount of free chlorine to the water when the level falls below the amount necessary to prevent contamination. As discussed herein, apparatus 10 also is capable of detecting the quantity of total dissolved solids present in the water. Apparatus 10 is also capable of filtering suspended solids. In addition, apparatus 10 functions to selectively add minerals to the water when the pH level falls below a predetermined level. This capability is particularly useful when the stored water has been produced by reverse-osmosis which tends to produce potable water with low mineral content and a low pH. By adding minerals to such water that neutralize the pH level, apparatus 10 prevents corrosion of any metal piping downstream of the system and provides for a more nutritional water source.

Once or twice a year, apparatus 10 may be used to “shock treat” the water. During shock treatment, chlorine pump 18 is activated to deliver chlorine from chlorine tank 20 in an amount sufficient to “shocks” the water and thereby remove all contamination from the water and those parts of the water distribution system the shocked water comes into contact with. Typically, to shock the system, chlorine is added to the water in the amount of 50 ppm.

Apparatus 10 can also be used to de-chlorinate the water stored in tank 32. Chemicals that remove or render chlorine inactive may be placed in tank 20 and pumped into the water loop via pump 18. Dispersal of the de-chlorination chemical through the system will remove or make the chlorine inactive. Such de-chlorination chemicals include sodium metabisulfite.

While preferred embodiments of the present invention have been described, it is to be understood that the embodiments are illustrative only and that the scope of the invention is to be defined solely by the appended claims when accorded a full range of equivalents, many variations and modifications naturally occurring to those skilled in the art from a review hereof.

What is claimed is:

1. An apparatus for maintaining potable water, comprising:
a frame assembly including a bottom plate and a frame support structure, said bottom plate having a topside and an underside, said frame support structure affixed to said topside of said bottom plate;
a plurality of conduits for transporting said potable water, said plurality of conduits being in fluid communication;
a circulation pump in fluid communication with said plurality of conduits, said circulation pump capable of pumping said potable water through said plurality of conduits;
a sensor array assembly in fluid communication with said plurality of conduits, said sensor array assembly including a first sensor probe capable of detecting an amount of free chlorine present in said potable water, a second sensor probe capable of detecting a pH level of said potable water, and a third sensor probe capable of detecting an amount of total dissolved solids in said potable water;
a chlorine tank in fluid communication with said plurality of conduits;
a chlorine dosing pump in fluid communication with said plurality of conduits and with said chlorine tank, said chlorine dosing pump being selectively activated in response to the detection by said first sensor probe of said amount of free chlorine in said potable water to cause said chlorine tank to deliver a specified amount of chlorine into said potable water;
a mineral tank in fluid communication with said plurality of conduits, said mineral tank capable of selectively delivering a specified amount of minerals into said potable water in response to the detection by said second sensor probe of said pH level in said potable water; and
a filter assembly in fluid communication with said plurality of conduits, said filter assembly capable of selectively filtering said potable water to remove a predetermined particle size of suspended solids from said potable water.

2. The apparatus according to claim 1, further comprising a pressure switch in fluid communication with said plurality of conduits, said pressure switch capable of protecting the circulation pump from running dry.

3. The apparatus according to claim 2, further comprising a first plurality of valve means operatively associated with said mineral tank, and wherein said selective delivery of said specified amount of minerals into said potable water in response to the detection by said second sensor probe of said pH level in said potable water is caused by actuation of said first plurality of valve means.

4. The apparatus according to claim 3, wherein said first plurality of valve means is selected from the group consisting of ball valves, spring loaded check valves, diaphragm valves and pilot solenoid valves.

5. The apparatus according to claim 3, further comprising a second plurality of valve means operatively associated with said filter assembly, and wherein said selective filtering of said potable water to remove said predetermined particle size of suspended solids from said potable water.

6. The apparatus according to claim 5, wherein said second plurality of valve means comprises ball valves.

7. The apparatus according to claim 1, wherein said plurality of conduits comprises PVC piping.

8. The apparatus according to claim 1, wherein said filter assembly comprises a filter cartridge.

9. The apparatus according to claim 1, wherein said filter assembly comprises a plurality of filter cartridges.

10. The apparatus according to claim 1, wherein one of said plurality of conduits includes an inlet for entry of said potable water from a storage tank and one of said plurality of conduits includes an outlet for discharge of said potable water to said storage tank, and wherein said apparatus further comprises a discharge member in fluid communication with said outlet, said discharge member including a longitudinally extending distribution arm containing a plurality of spaced-apart discharge orifices capable of distributing said potable water discharged from said outlet into said storage tank.

11. The apparatus according to claim 10, wherein said spaced-apart discharge orifices each have a differently sized inner diameter.

12. The apparatus according to claim 11, wherein said spaced-apart discharge orifices are positioned on said distribution arm in axial alignment from an upper section of said distribution arm to a lower section of said distribution arm with said orifice having the smallest sized inner diameter positioned in said upper section and said orifice with said largest sized inner diameter positioned in said lower section.

13. An apparatus for maintaining potable water, comprising:
a frame assembly including a bottom plate and a frame support structure, said bottom plate having a topside and an underside, said frame support structure affixed to said topside of said bottom plate;
a plurality of conduits for transporting water, said plurality of conduits being in fluid communication;
a circulation pump in fluid communication with said plurality of conduits, said circulation pump capable of pumping said potable water through said plurality of conduits;
a sensor array assembly in fluid communication with said plurality of conduits, said sensor array assembly including a first sensor probe capable of detecting an amount of free chlorine present in said potable water, a second sensor probe capable of detecting a pH level of said potable water, and a third sensor probe capable of detecting an amount of total dissolved solids in said potable water;
a chlorine tank in fluid communication with said plurality of conduits;
a chlorine dosing pump in fluid communication with said plurality of conduits and with said chlorine tank, said chlorine dosing pump being selectively activated in response to the detection by said first sensor probe of said amount of free chlorine in said potable water to cause said chlorine tank to deliver a specified amount of chlorine into said potable water;
a mineral tank in fluid communication with said plurality of conduits, said mineral tank capable of selectively delivering a specified amount of minerals into said potable water in response to the detection by said second sensor probe of said pH level in said potable water; and
a filter assembly in fluid communication with said plurality of conduits, said filter assembly capable of selectively filtering said potable water to remove a predetermined particle size of suspended solids from said potable water;
a control panel operatively associated with said first, second and third sensor probes, said control panel including a plurality of visual instrument displays; and
an electrical junction box housing a plurality of electrical leads, said junction box operatively connected to said control panel and to said chlorine pump.

14. The apparatus according to claim 13, wherein said control panel includes an alarm providing a visual signal, audible signal, or combination of a visual and audible signal in response to a malfunction of said apparatus.

15. The apparatus according to claim 13, wherein said plurality of conduits includes a bypass line capable of diverting a portion of said potable water to a return line that discharges said portion of the potable water into a storage tank prior to said portion of said potable water entering said mineral tank and said filter assembly.

16. A method of maintaining potable water stored in a storage tank, said storage tank having an outlet means and an inlet means, said method comprising the steps of:
a) providing an apparatus comprising: a frame assembly including a bottom plate and a frame support structure, said bottom plate having a topside and an underside, said frame support structure affixed to said topside of said bottom plate; a plurality of conduits for transporting said potable water, said plurality of conduits being in fluid communication, one of said plurality of conduits having an inlet for entry of said potable water stored in said storage tank and one of said plurality of conduits having an outlet for return of said potable water to said storage tank; a circulation pump in fluid communication with said plurality of conduits, said circulation pump capable of pumping said potable water through said plurality of conduits; a sensor array assembly in fluid communication with said plurality of conduits, said sensor array assembly including a first sensor probe capable of detecting an amount of free chlorine present in said potable water, a second sensor probe capable of detecting a pH level of said potable water, and a third sensor probe capable of detecting an amount of total dissolved solids in said potable water; a chlorine tank in fluid communication with said plurality of conduits; a chlorine dosing pump in fluid communication with said plurality of conduits and with said chlorine tank, said chlorine dosing pump being selectively activated in response to the detection by said first sensor probe of said amount of free chlorine in said potable water to cause said chlorine tank to deliver a specified amount of chlorine into said potable water; a mineral tank in fluid communication with said plurality of conduits, said mineral tank capable of selectively delivering a specified amount of minerals into said potable water in response to the detection by said second sensor probe of said pH level in said potable water; and a filter assembly in fluid communication with said plurality of conduits, said filter assembly capable of selectively filtering said potable water to remove a predetermined particle size of suspended solids from said potable water;
b) placing said inlet of said one of said plurality of conduits in fluid communication with said outlet means of said storage tank;
c) placing said outlet of said one of said plurality of conduits in fluid communication with said inlet means of said storage tank;
d) activating said circulation pump to pump said potable water stored in said storage tank through said plurality of conduits;
e) causing a first stream of said potable water to pass through said sensor array assembly wherein said first sensor probe detects said amount of free chlorine present in said potable water, said second sensor probe detects said pH level of said potable water, and said third sensor probe detects said amount of total dissolved solids in said potable water;
f) causing a second stream of said potable water to be selectively directed through said plurality of conduits in response to the detection by said second sensor probe of said pH level of said potable water; and
g) causing activation of said chlorine pump to add a specified amount of a diluted chlorine mixture contained in said chlorine tank to said potable water or maintaining an inactive state of said chlorine pump in response to the detection by said first sensor probe of said amount of free chlorine in said potable water.

17. The method according to claim 16, wherein in step (f), said second stream of said potable water is caused to be diverted through said plurality of conduits so as to by-pass said mineral tank and said filter assembly.

18. The method according to claim 16, wherein in step (f), said second stream of said potable water is caused to be partially diverted through said plurality of conduits for entry into said mineral tank for addition of a specified amount of minerals while by-passing said filter assembly.

19. The method according to claim 16, wherein in step (f), said second stream of said potable water is caused to be partially diverted through said plurality of conduits for entry into said mineral tank for addition of a specified amount of minerals and partially diverted through said plurality of conduits for entry into said filter assembly for filtering of said suspended solids.

20. The method according to claim 16, wherein in step (e), said first stream of said potable water passing through said sensor array assembly is selectively controlled at a flow rate of 1 to 5 gallons per minute.

21. The method according to claim 20, wherein in step (e), said first stream of said potable water passing through said sensor array assembly is selectively controlled at a flow rate of about 3 gallons per minute.

22. The method according to claim 18, wherein said partially diverted second stream of said potable water entering said mineral tank is selectively controlled at a flow rate of 10 to 50 gallons per minute.

23. The method according to claim 22, said partially diverted second stream of said potable entering said mineral tank is selectively controlled at a flow rate of about 10 gallons per minute.
